(19) United States
(12) Patent Application Publication
(10) Pub. No.: US 2025/0229385 A1
(43) Pub. Date: Jul. 17, 2025

(54) MULTI-WAY FAUCET AERATOR TOOL

(71) Applicant: JS Products, Inc., Las Vegas, NV (US)

(72) Inventor: Chungeng Chen, Las Vegas, NV (US)

(21) Appl. No.: 19/019,883

(22) Filed: Jan. 14, 2025

Related U.S. Application Data
(60) Provisional application No. 63/621,785, filed on Jan. 17, 2024.

(51) Int. Cl. B25B 13/02

(52) U.S. Cl. CPC B25B 13/02

(57) ABSTRACT

A multi-way faucet aerator tool is provided. The tool includes a body element, a plurality of cylindrical-shaped tool heads extending outwardly from the body element, and an additional tool element associated with the body element. Each tool head has a different aerator key element configuration. The additional tool element includes a body portion extending from the body element, a lid movably coupled to the body portion, and means for connecting the aerator tool to another object.

### RELATED APPLICATION DATA

This application claims priority to U.S. Provisional Patent Application Ser. No. 63/621,785, filed Jan. 17, 2024, and incorporates by reference said application as if set forth fully herein.

### FIELD OF THE INVENTION

The present invention relates to tools for installing and removing faucet aerators.

### BACKGROUND OF THE INVENTION

Faucets commonly include plumbing, faucet heads connected to the plumbing, and aerators coupled to the faucet heads for aeration purposes. These aerators generally include a body for coupling to the faucet, and an associated aerator screen through which the water flows. From time to time, it is important that the aerator, including the associated aerator screen, be removed from the faucet head so that it can be cleaned and/or replaced. Special tools are employed to properly grip the aerators and cause the aerators to rotate with respect to the faucet heads. However, not all aerators have the same configuration (they generally include one of a number of different opening patterns for accepting mating tool keys). In order to install or remove these different aerators, users are often forced to use a plurality of different tools, each corresponding to a different configuration aerator. This undesirably requires a user to purchase, store and track a number of aerator installation and removal tools.

Furthermore, while some faucet aerator tools have more than one tool element integrated into a single tool, these known tools are generally expensive to manufacture, bulky and not ergonomic. Additionally, these tools are also often undesirably limited in that generally the only capability they provide is to install and remove aerators.

It is with respect to these and other considerations that the instant disclosed concept is concerned.

### SUMMARY OF THE INVENTION

One aspect of the invention is directed to a multi-way faucet aerator tool. The tool includes a body element, a plurality of cylindrical-shaped tool heads extending outwardly from the body element, and an additional tool element associated with the body element. Each tool head has a different aerator key element configuration. The additional tool element includes a body portion extending from the body element, a lid movably coupled to the body portion, and means for connecting the aerator tool to another object.

Another aspect is directed to a multi-way faucet aerator tool which comprises a body element; a plurality of cylindrical-shaped tool heads extending outwardly from the body element, each tool head having a different aerator key element configuration; and an additional tool element associated with the body element. The additional tool element comprises a body portion extending from the body element, and a lid movably coupled to the body portion. The lid and the body portion cooperate to define an openable and closeable storage compartment for one or more aerator screens.

In one example, the aerator tool includes five tool heads each extending outwardly from the body element, with four of the tool heads extending from the body element in directions perpendicular to an axis of a first tool head and the additional tool element.

In another example, the lid is configured to be maintained in a closed position, with respect to the body portion, via a magnet element coupled to the lid, and another magnet element coupled to the body portion.

In yet another example, the lid is configured to be maintained in a closed position, with respect to the body portion, via a bolt that is configured to be threadably coupled to the body portion when the lid is in a closed position.

Further objects, features, and advantages of the present invention over the prior art will become apparent from the detailed description of the drawings which follows, when considered with the attached figures.

### DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 shows an isometric view of a multi-way faucet aerator tool, in accordance with one non-limiting aspect of the disclosed concept;

FIG. 2 shows a top plan view of the tool of FIG. 1;

FIG. 3 shows a front view of the tool of FIG. 1;

FIG. 4 shows a rear view of the tool of FIG. 1;

FIG. 5 shows a bottom view of the tool of FIG. 1;

FIG. 6 shows a left side view of the tool of FIG. 1;

FIG. 7 shows a right side view of the tool of FIG. 1;

FIG. 8 shows another isometric view of the tool of FIG. 1, with a lid thereof in an open position;

FIG. 9 shows a section view of the tool of FIG. 1; and

FIG. 10 shows a view of another multi-way faucet aerator tool, with a lid thereof in an open position, in accordance with another non-limiting aspect of the disclosed concept.

### DETAILED DESCRIPTION OF THE INVENTION

In the following description, numerous specific details are set forth in order to provide a more thorough description of the present invention. It will be apparent, however, to one skilled in the art, that the present invention may be practiced without these specific details. In other instances, well-known features have not been described in detail so as not to obscure the invention.

As employed herein, the term “coupled” shall mean connected together either directly or via one or more intermediate parts or components. Being “coupled” includes, for example and without limitation, one component being molded to, or overmolded with respect to, another component.

As employed herein, the term “number” shall mean an integer greater than zero (e.g., one, two, three, four, etc.).

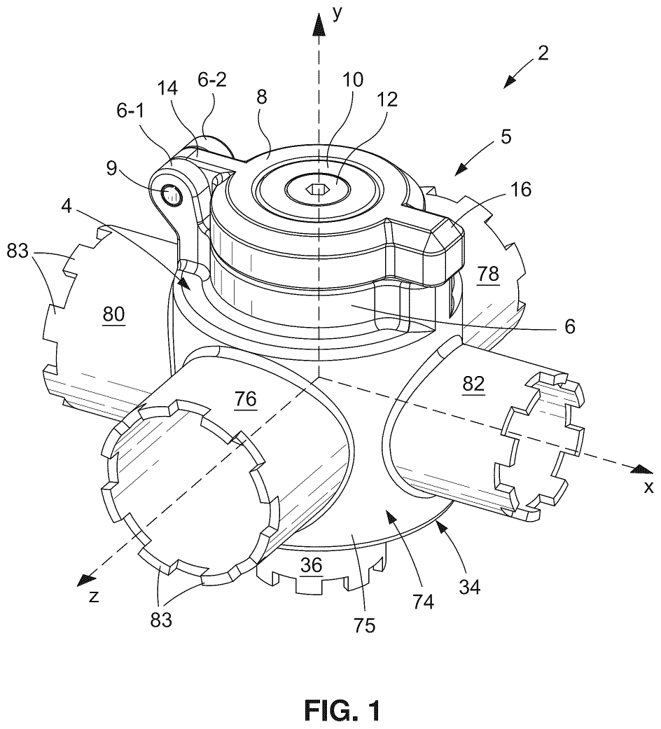

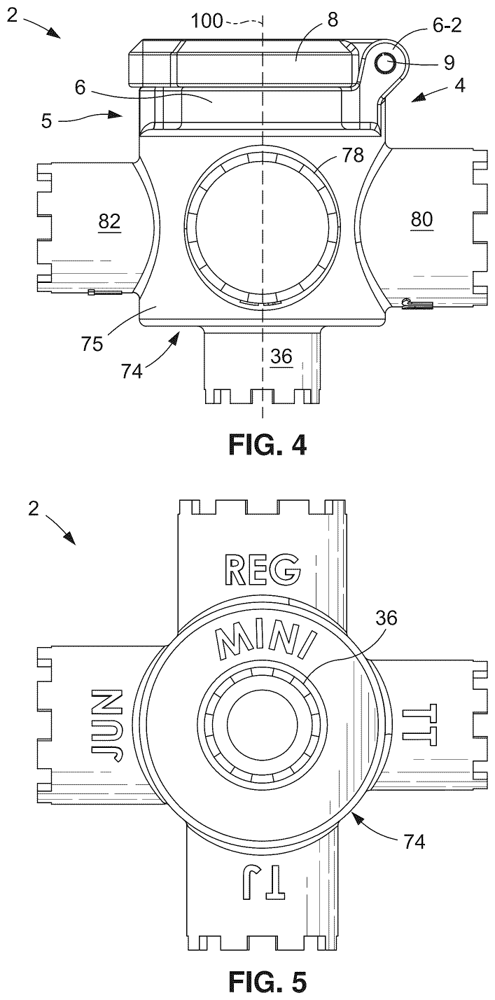

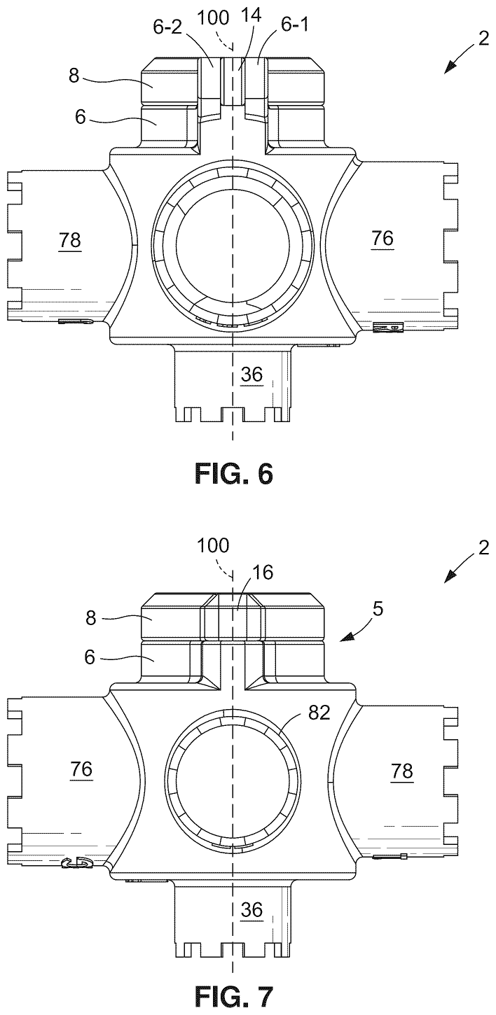

FIGS. 1-9 show different views of a multi-way faucet aerator tool 2. In general, the tool 2 includes a plurality of aerator tools heads which are configured to engage faucet aerators of different configurations, for the purpose of installing or removing them from a corresponding faucet. The tool 2 preferably also includes a storage area for one or more aerator screens, and a tool mount. In a preferred embodiment, the tool 2 includes a plurality of aerator tool heads all associated with a single body element.

As shown in FIG. 1, in one embodiment, the tool 2 has a body element 74 which has a top 4 and a bottom 34 located opposite and facing away from the top 4. In one configuration, the body element 74 is cylindrically shaped and thus has a generally cylindrical sidewall 75 between the top 4 and the bottom 34.

In one example, the tool 2 includes a plurality of tool elements or optionally cylindrical-shaped tool heads, such as a first tool head 36, a second tool head 76, a third tool head 78, a fourth tool head 80, and fifth tool head 82. The tool heads 36 and 76 and 78 and 80 and 82 preferably extend outwardly from the body element 74, and each have a different aerator key element configuration. In one example, each of the tool heads 36 and 76 and 78 and 80 and 82 and an additional tool element 5, discussed below, extend outwardly from the body element 74 perpendicular to one another. In a more preferred embodiment, the first tool head 36 and the additional tool element 5 extend outwardly from the body element 74 in opposite directions along a common axis 100 (see FIG. 3), and each of the other tool heads 76 and 78 and 80 and 82 extend outwardly from the body element 74 in four corresponding directions perpendicular to the common axis 100.

In a preferred configuration, the tool heads 36 and 76 and 78 and 80 and 82 are arranged perpendicular to one another, such as in relation to X, Y and Z axes of an orthogonal/Cartesian arrangement through the tool 2 as illustrated in FIG. 1. Thus, in one configuration, the first tool head 36 extends downwardly from the body element 74, such as along a Y axis therethrough. The second tool head 76 and the third tool head 78 extend outwardly from the sidewall 75 of the body element 74 in opposing directions and generally perpendicular to the Y axis extending through the tool 2—such as along the Z axis. The fourth tool head 80 and the fifth tool head 82 extend outwardly from the sidewall 75 of the body element 74 in opposing directions and generally perpendicular to the first tool head 36 and the Y axis, and perpendicular to the second and third tools heads 76, 78 and the Z axis, such as along the X axis.

In one example, the tool heads 36 and 76 and 78 and 80 and 82 are all cylindrically or cylinder shaped. For example, each of the tool heads 36 and 76 and 78 and 80 and 82 may be defined by a cylindrical wall which has a first or proximal end connected to the body element 74 and a second or distal end located outwardly therefrom (although in other configurations, the bodies of the tool heads might be solid). Each tool head 36 and 76 and 78 and 80 and 82 preferably defines or includes a plurality of key elements 83 (not all key elements are labeled) which extend outwardly, preferably in a spaced arrangement around the periphery of the distal portion of the head (opposite its connection to the body element 74). The particular configuration of the key elements 83, such as the width and spacing thereof on each head, preferably corresponds to at least one of a particular aerator configuration.

Further, the configuration of the key elements 83 may have different diameters, such that the tool heads 36 and 76 and 78 and 80 and 82 may each have outside diameters D1 and D2 and D3 and D4 and D5 which may vary, such as corresponding to the particular aerator design. That is, each to the tool heads 36 and 76 and 78 and 80 and 82 preferably has a different corresponding diameter. For example, in one configuration, the tool heads 36 and 76 and 78 and 80 and 82 have key configurations which are configured to mate with aerators having known “Regular”, “Junior”, “Mini”, “TJ” and “TT” configurations (which have diameters of 16.5 mm, 18.5 mm, 21.5 mm, 22.5 mm and 24 mm).

Of course, the tool heads 36 and 76 and 78 and 80 and 82 might have other configurations, such as to correspond to other faucet aerator configurations which are now known or later developed. Further, while the example tool 2 is configured to work with five different configurations of aerators, the tool 2 might include additional tool heads.

In a preferred configuration, the tool 2 includes the five tool heads 36 and 76 and 78 and 80 and 82, and further includes the additional tool element 5, which is associated with the body element 74, and preferably extends outwardly from the top 4, in an opposing direction from the first tool head 36.

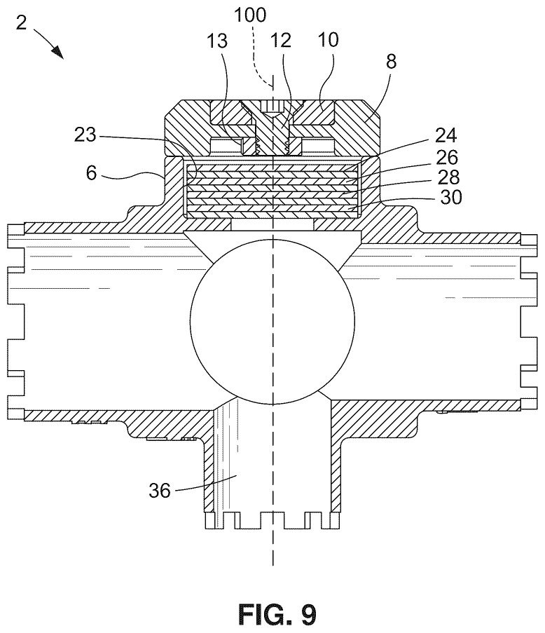

This additional tool element 5 may comprise a tool holder. In one configuration, the tool holder of the additional tool element 5 is both configured to facilitate mounting of the tool 2 to another object, and to also provide a storage area, such as for one or more aerator screens 24 and 26 and 28 and 30 (FIG. 9).

In one embodiment, the tool holder of the additional tool element 5 has a body portion 6 extending from the body element 74, and a cover or lid 8 movably (i.e., pivotally) coupled to the body portion 6. In one example, the lid 8 and the body portion 6 cooperate to define an openable and closeable storage compartment 23 for the one or more aerator screens 24 and 26 and 28 and 30 (FIG. 9). That is, the lid 8 preferably moves between an open position and a closed position. Additionally, in one embodiment, means are provided for connecting or mounting the tool 2 to another object.

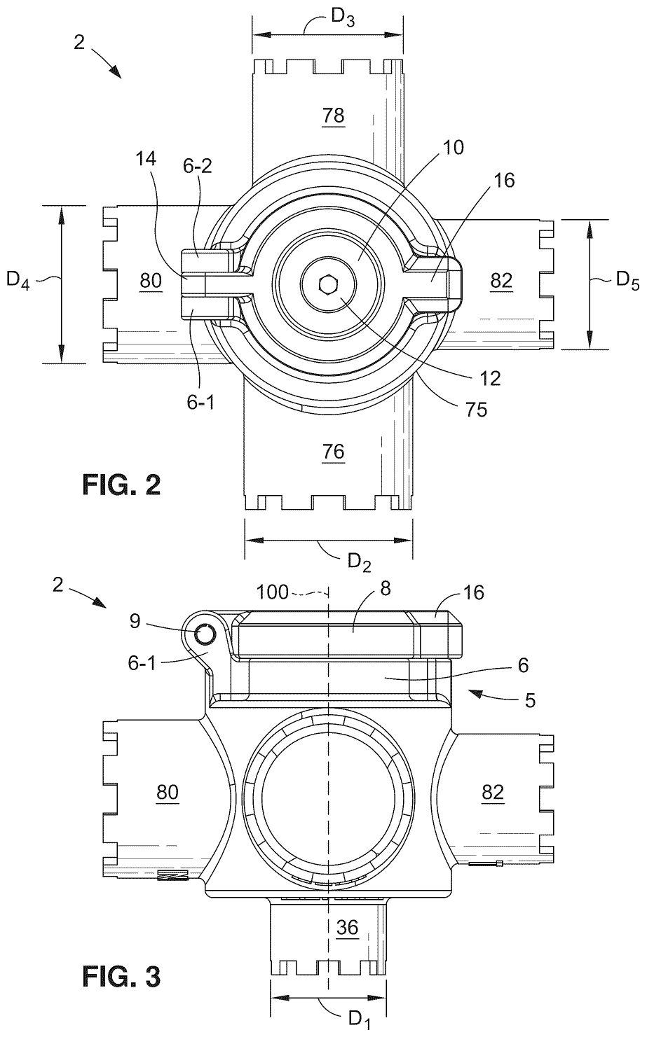

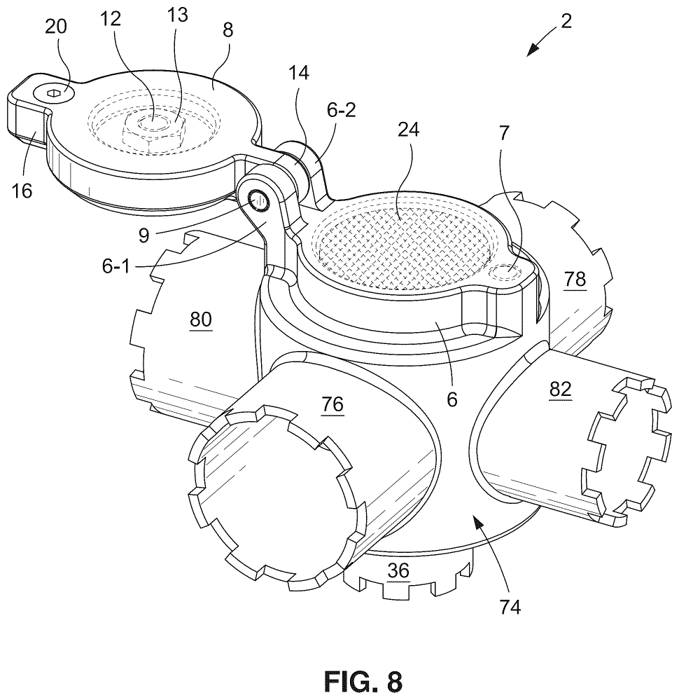

In one configuration, this means includes a magnet element 10 coupled to the lid 8, and one or more coupling members (e.g., threaded fastener/bolt 12 shown in FIGS. 1 and 2, and associated connector or nut 13 shown in phantom line drawing in FIG. 8). The threaded fastener/bolt 12 and the nut 13 cooperate with each other (e.g., are threadably coupled) in order to couple the magnet element 10 to the lid 8, such as via the threaded fastener/bolt 12 extending through the magnet element 10, through the lid 8, and at least partially through the nut 13.

As shown in FIG. 9, the threaded fastener/bolt 12 is configured to be located perpendicular to each of the aerator screens 24 and 26 and 28 and 30 when the lid 8 is in the closed position. Furthermore, the magnet element 10 may be used for a variety of purposes, including connecting the tool 2 to another object, such as to hold it while working.

In one example, the body element 74, the body portion 6, and the tool heads 36 and 76 and 78 and 80 and 82 are formed as a unitary component made from a single piece of material. That is, these features of the tool 2 may together be a single molded piece made of monomeric and/or polymeric materials, such as formed in a molding process. As a result, the tool 2 is relatively simple to manufacture, relatively high-strength, and in this design, compact and ergonomic.

Referring again to FIGS. 1, 2 and 8, the cover or lid 8 is preferably movably connected to the body element 74, relative to an interior storage area or compartment 23 defined by the body element 74. This may be achieved by the lid 8 including first and second opposing distal extensions 14 and 16, each extending outwardly from a central body portion in opposing directions. As shown, the first distal extension 14 has a thru hole and is configured to be located between opposing extensions 6-1 and 6-2 of the body portion 6, thus effectively forming a hinge.

In this manner, a pin 9 (FIG. 1) of the tool 2 preferably extends at least partially through the thru hole of the distal extension 14, as well as through the opposing extensions 6-1 and 6-2 of the body portion 6. This allows the lid 8 to pivot, with respect to the body portion 6, between a CLOSED position, shown in FIGS. 1-4, 6, and 7, and an OPEN position, shown in FIG. 8. Additionally, it will be appreciate that when the lid 8 is in the CLOSED position, the lid 8 extends from the pin 9 to the first and second magnet elements 7 and 20.

As shown in FIGS. 1, 2, and 8, the nut 13 (FIG. 8) is threadably coupled to the threaded fastener/bolt 12 in order to maintain the magnet element 10 (FIGS. 1 and 2) on the lid 8. That is, the threaded fastener/bolt 12 preferably extends through the magnet element 10, which is located in a recessed pocket of the lid 8. Of course, the magnet element 10 might be connected or secured to the lid 8 in other manners, such as with adhesive, other configurations of fasteners, and even by molding the magnet element into the lid 8.

In one embodiment, means are provided for selectively maintaining the lid 8 in its CLOSED position. In one configuration, this means comprises an additional magnet element 20 coupled to the lid 8, and a magnet element 7 coupled to the body portion 6 (or vice versa). Thus, the magnet element 20 and magnet element 7 are magnetically attracted to each other and cooperate with each other in order to maintain the lid 8 in the CLOSED position. Additionally, overcoming the magnetic attractive force between the magnet elements 7 and 20, such as by a user pulling the lid 8 with a predetermined amount of force, causes the lid 8 to move from the CLOSED position to the OPEN position. Of course, other fasteners might be used, such as a threaded fastener, a clasp, etc.

Furthermore, the tool 2 preferably defines the storage area or compartment 23, such as located within the body element 74. The compartment 23 preferably has a circular and tubular-shaped wall in order to receive the aerator screens 24 and 26 and 28 and 30. As illustrated in FIG. 9, a number (e.g., four are shown) of aerator screens 24 and 26 and 28 and 30 may be located in the compartment 23. The aerator screens 24 and 26 and 28 and 30 may, in one example, be generally planar mesh-type components.

In use, a user may use one of the tool heads 36 and 76 and 78 and 80 and 82 in order to remove an aerator (not shown) from a faucet (not shown), such as to clean or replace the aerator screen (not shown) thereof. In general, the correct tool head 36 and 76 and 78 and 80 and 82 is selected and is pressed into engagement with the aerator body so that the keys 83 thereon engage mating portions of the aerator body (and where a portion of the aerator body may be received in the open portion of the tool head). The tool 2 is rotated to remove the aerator from the faucet.

In the event the aerator screen (not shown) needs to be placed, the user can open the lid 8 of the tool 2 to access the compartment 23, such as to access one of the stored aerator screens 24 and 26 and 28 and 30, and subsequently use said one of the stored aerator screens 24 and 26 and 28 and 30 on a corresponding faucet head (not shown). This includes using one of the tool heads 36 and 76 and 78 and 80 and 82 to then connect said one of the stored aerator screens 24 and 26 and 28 and 30 to the faucet (not shown).

The tool 2 may similarly be used to tighten an aerator onto a faucet. Also, when not in use, the user may conveniently attach the tool 2 to another object, such as an adjacent pipe, by locating the magnet element 10 close to a metal object. This frees the user's hands while performing a different task, but keeps the tool 2 in close proximity for later use.

As indicated, the tool 2 may have other configurations. For example, although less preferred, the lid 8 might be configured to snap onto or screw onto the body portion 6.

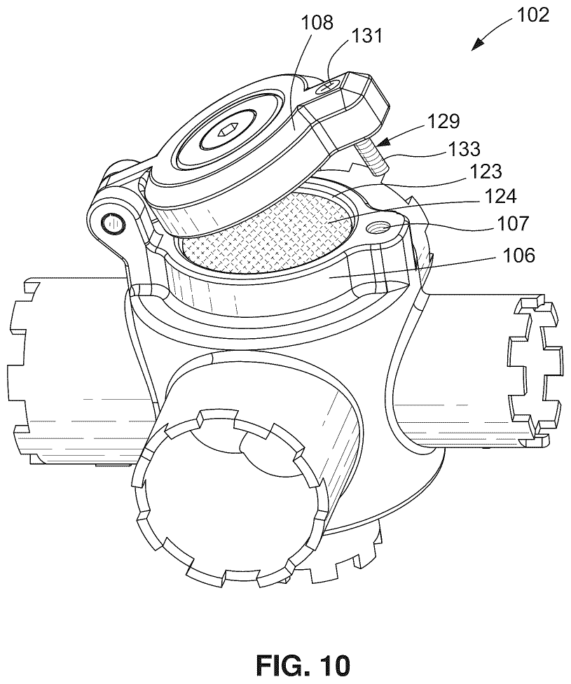

As another example, FIG. 10 shows an example of another faucet tool 102, which is similar to the faucet tool 2 (FIGS. 1-9), and wherein like numbers represent like features. As shown in FIG. 10, the tool 102, unlike the tool 2, includes a coupling member coupled to the lid 108, which may be fastener (e.g., a threaded fastener such as a bolt 129) for securing the lid 108 in a CLOSED position (not shown). The bolt 129 may include a head portion 131 and a threaded body portion 133 extending from the head portion 131. The head portion 131 is preferably maintained either above the lid 108 or in a recessed region of the lid 108, and the threaded body portion 133 preferably extends through the lid 108 and threadably couples within a threaded aperture 107 of the body portion 106.

Put differently, the bolt 129 is configured to extend into and optionally be threably coupled to the body portion 133 in order to maintain the lid 108 in the closed position. In this manner, when a user of the tool 102 desires to access the compartment 123 in order to retrieve an aerator screen 124, all the user needs to do is unscrew the bolt 129 such that the threaded body portion 133 is no longer threaded into the aperture 107. In other words, by unscrewing the bolt 129, the lid 108 can readily be pivoted to the OPEN position (FIG. 10), thereby allowing the aerator screen 124 to be accessed.

The tools 2 and 102 of the invention are compact and ergonomic multi-head aerator tools, advantageously providing additional functionality such as mounting and storage features.

It will be understood that the above-described arrangements of apparatus and the method there from are merely illustrative of applications of the principles of this invention and many other embodiments and modifications may be made without departing from the spirit and scope of the invention as defined in the claims.

What is claimed is:

1. A multi-way faucet aerator tool, comprising:
a body element;
a plurality of cylindrical-shaped tool heads extending outwardly from the body element, each tool head having a different aerator key element configuration; and
an additional tool element associated with the body element, the additional tool element comprising:
a body portion extending from the body element,
a lid movably coupled to the body portion, and
means for connecting the aerator tool to another object.

2. The tool according to claim 1, wherein said means comprises a magnet element coupled to said lid.

3. The tool according to claim 2, wherein said means further comprises a first coupling member and a second coupling member cooperating with each other to couple said magnet element to said lid, and wherein said first coupling member extends through said magnet element, through said lid, and at least partially through said second coupling member.

4. The tool according to claim 3, wherein said lid and said body portion cooperate to define an openable and closeable storage compartment for one or more aerator screens, and wherein said first coupling member is configured to be disposed perpendicular to each of said one or more aerator screens when said lid is in a closed position.

5. The tool according to claim 1, wherein said lid and said body portion cooperate to define an openable and closeable storage compartment for one or more aerator screens.

6. The tool according to claim 5, wherein said lid is movable between an open position and a closed position, wherein said additional tool element further comprises a first magnet element coupled to said body portion, and a second magnet element coupled to said lid, and wherein said first and second magnet elements cooperate with each other to maintain the lid in the closed position.

7. The tool according to claim 6, wherein said additional tool element further comprises a pin extending through each of said body portion and said lid in order to allow said lid to pivot with respect to said body portion, and wherein, when said lid is in the closed position, said lid extends from said pin to said first and second magnet elements.

8. The tool according to claim 5, wherein said lid is movable between an open position and a closed position, wherein said additional tool element further comprises a coupling member coupled to said lid, and wherein said coupling member is configured to extend into said body portion in order to maintain said lid in the closed position.

9. The tool according to claim 8, wherein said coupling member is a bolt configured to be threadably coupled to said body portion when said lid is in the closed position.

10. The tool according to claim 5, wherein said storage compartment has a circular and tubular-shaped wall in order to receive the one or more aerator screens.

11. The tool according to claim 5, wherein said tool heads comprise five tool heads, and wherein each of said five tool heads and said additional tool element extend outwardly from said body perpendicular to one another.

12. The tool according to claim 11, wherein said five tool heads comprises a first tool head, a second tool head, a third tool head, a fourth tool head, and a fifth tool head, wherein said first tool head and said additional tool element extend outwardly from said body element in opposite directions along a common axis, and wherein each of said second tool head, said third tool head, said fourth tool head, and said fifth tool head extend outwardly from said body element in four corresponding directions perpendicular to the common axis.

13. The tool according to claim 11, wherein each of said five tool heads has a different corresponding diameter.

14. A multi-way faucet aerator tool, comprising:
a body element;
a plurality of cylindrical-shaped tool heads extending outwardly from the body element, each tool head having a different aerator key element configuration; and
an additional tool element associated with the body element, the additional tool element comprising a body portion extending from the body element, and a lid movably coupled to the body portion, said lid and said body portion cooperating to define an openable and closeable storage compartment for one or more aerator screens.

15. The tool according to claim 14, wherein said storage compartment has a circular and tubular-shaped wall in order to receive the one or more aerator screens.

16. The tool according to claim 14, wherein said additional tool element further comprises a first magnet element coupled to said body portion, and a second magnet element coupled to said lid, and wherein said first and second magnet elements cooperate with each other to maintain the lid in a closed position.

17. The tool according to claim 16, wherein said additional tool element further comprises a pin extending through each of said body portion and said lid in order to allow said lid to pivot with respect to said body portion, and wherein, when said lid is in the closed position, said lid extends from said pin to said first and second magnet elements.

18. The tool according to claim 14, wherein said additional tool element further comprises a coupling member coupled to said lid, and wherein said coupling member is configured to extend into said body portion in order to maintain said lid in a closed position, with respect to said body portion.

19. The tool according to claim 18, wherein said coupling member is a bolt configured to be threadably coupled to said body portion when said lid is in the closed position.

20. The tool according to claim 14, wherein said tool heads comprise five tool heads, and wherein each of said five tool heads and said additional tool element extend outwardly from said body perpendicular to one another.
